(19) United States
(12) Patent Application Publication
(10) Pub. No.: US 2023/0286838 A1
(43) Pub. Date: Sep. 14, 2023

(54) Electromagnetic Treatment Apparatus of Fluids and Method Therefor

(71) Applicant: ARISTOTLE UNIVERSITY OF THESSALONIKI - E.L.K.E., Thessaloniki (GR)

(72) Inventors: Andreas Giannakoudakis, Thessaloniki (GR); Efstratios Stylianidis, Thessaloniki (GR); Panagiotis Barmpalexis, Thessaloniki (GR); Dimitrios Giannakoudakis, Thessaloniki (GR); Ioannis Sampris, Thessaloniki (GR)

(73) Assignee: ARISTOTLE UNIVERSITY OF THESSALONIKI - E.L.K.E., Panepistimioupoli Thessalonikis (GR)

(21) Appl. No.: 18/040,455

(22) PCT Filed: Aug. 3, 2021
(86) PCT No.: PCT/GR2021/000051

§ 371 Date: Feb. 3, 2023

(30) Foreign Application Priority Data
Aug. 3, 2020 (GR) 20200100458

(51) Int. Cl. C02F 1/48; C02F 1/00; A01G 33/00; A01G 25/00

(52) U.S. Cl. CPC C02F 1/484; C02F 1/005; A01G 33/00; A01G 25/00; C02F 2201/483; C02F 2103/026

(57) ABSTRACT

The invention relates to an apparatus for electromagnetic treatment of a fluid comprising an electromagnetic radiation generator means for generating an electromagnetic signal with a customized spreading and distribution in space, a one-dimensional array (10, 20) of coil means (11, . . . , 15) and same number of magnet means (21, . . . , 25) in alignment therewith, arranged peripherally on supporting means consisting of a pair of rotatable discs (1, 1′; 2, 2′) according to a circular pattern concentric about an axis (1), wherein said coil & magnet means (11, . . . , 25) are centered on the vertices of a regular pentagon or having a fivefold of vertices wherein said generated electromagnetic radiation signal (Sμ) associated to the pentagonal circuitry (11.25; 16) is related to the golden ratio (φ) defining the geometric proportion of the regular pentagon, wherein (I). It also relates to an electromagnetic treatment method.

$$φ = \frac{1 + \sqrt{5}}{2} ∼ 1 , 618. \qquad ( I )$$

### FIELD OF THE INVENTION

This invention relates to an electromagnetic treatment apparatus of water or other fluids in several applications, for producing an electromagnetized water resp. fluid whereby said fluid is treated by a specific electromagnetic field, for several purposes as farming and agricultural and industrial applications, environmental and household uses. More particularly, the present invention relates to devices using magnetic fields generated by the rotation of magnets.

### BACKGROUND OF THE INVENTION

It is known that the use of magnetically resp. electromagnetically treated fluids such as water, brings an improvement in several fields of science, industry, society etc., notably in agriculture, wherein traditional breeding technologies and proper management strategies continue to play a main role in crop improvement. However, conventional breeding methods have little success and have failed to provide desirable results. Therefore, the need of other tools for addressing the critical problems of crop improvement for sustainable agriculture is increasing.

Among several approaches, some closely related studies have reported beneficial effects of magnetic or electromagnetic fields in a number of farming situations. Many researchers have treated crop seeds with different magnetic fields, and they have succeeded to stimulate seed germination and seedling growth. Additionally, significant increases in plant height, root length, fresh and dry weights of different organs, specific leaf area, leaf area ratio, leaf weight ratio and leaf area index of several plants have also been reported as a result of (electro)magnetic water treatment.

In the field of industry, the implementation of said (electro)magnetic water treatment may lead to a significant reduction of scaling salts, such as carbonate, chloride and sulfate salts of Ca²⁺, Mg²⁺, Fe²⁺ and Fe³⁺ cations, and corrosion in industrial water facilitating systems, such as cooling towers, heat exchangers and boilers, pipelines etc.

For environmental respectively domestic purposes, the use of said (electro)magnetic treated water in sewage systems has shown to improve the treatment process, such as a purification process, in many aspects, notably accelerating the rate of solid sedimentation, improving the collection of fine fractions, decreasing the dissolved solids in the clarified water, etc. Additionally, said (electro)magnetic treated water improves the ability of water to dissolve waste and other compounds in houses, while less money is needed for restoring house plumbing (scaling reduction). Furthermore, less water is needed for garden irrigation.

As regards to mammal health and cattle breeding, several studies have shown that magnetized water is effective in alleviating colds, coughs, bronchitis, all types of fever and more, arthritis pain, reducing blood pressure, recovering quickly from a stroke, and it has revealed helpful in the regularization of women's menses. Also, treatment with magnetic water was very effective in breaking up kidney and gall bladder stones into small particles. Additionally, effectiveness of magnetized water in the prevention and treatment of atherosclerosis has been shown in some animal and human studies. Magnetized drinking water improves nutrient digestibility, saves water consumption, optimizing rumen fermentation parameters, and it could constitute an effective way to reduce methane production, thereby contributing to mitigate environmental impact in livestock, thus positive animal health: this is reflected in the increase in milk yield and its components and improves blood picture and antioxidant status. Besides, magnetized drinking water not only results in an increased milk production, mutton, and wool in sheep, but also in more weight-gain in geese and egg production, whereas hatchability in turkey can be achieved, as well as an increase in milk yields in dairy cows and ewes.

Also in health, said (electro)magnetized water has been used in cosmetics, as well as in pharmaceutical product development. For example, several studies, have shown that said magnetized water can be used as an adjunct to mouthwashes or toothpastes, since it shows high activity against S. mutans and it has a better action against plaque compared with saliva. Additionally, said (electro)magnetized water is highly effective against the growth of several microorganisms, compared to unmagnetized water, which may facilitate the preparation of more stable aqueous-based cosmetic and pharmaceutical products. Additionally, the use of said magnetized water results in decreased blood glucose and glycated hemoglobin levels, as well as in reduced blood and liver DNA damages.

US2006/0138891 discloses as background yet a rotating magnetic device utilizing sacred geometry for example purpose, referring to basic geometrical patterns exemplified by the so-called seed of live pattern used therein, whereas several other sacred geometrical shapes and patterns were merely cited, without being developed though, such as vesica pisces, the Kathara grid, rectangles, squares, equilateral triangles, hexagrams, etc. . . . . The developed example consists of six magnets with a lens shape of the elements of said seed of live, further disclosing that said seed of live pattern is made up of 6 resp. 12 lens-shaped magnets, further including a 3-dimensional array of magnets arranged on one single support plate.

Likewise with US2008/0296162 of same applicant Shallcross is based again on a magnetic device embodying sacred geometry but involving a multi-rotator-resonator, still working with similar magnets in the above-mentioned “seed of live” pattern, again with a lens-like profile and in the amount of 6 as illustrated in the figures. It discloses a multi-rotator magnetic resonator embodying sacred geometry yet, but again with only the same amount of 6 resp. 18 magnets holders having a plurality of recesses accommodating a single magnet.

### PRIOR ART

Many designs of commercial electromagnetic or just magnetic treatment devices are available: some of them use electromagnets, whilst others use single or arrays of permanent magnets.

Many such methods and devices are disclosed in the following patents notably: U.S. Pat. No. 4,659,479 discloses a device for treating aqueous solutions with magnetic lines of force and a pipe through which the solution passes. In said device, an electromagnetic coil is arranged so as to surround the pipe and a core consisting of endwise connected alternating short sections of magnetic and nonmagnetic material is disposed along the pipe's axis. Located between the pipe and the core is a helical baffle.

EP0338697 further discloses a method and a system for utilizing electromagnetic energy to inhibit, prevent, reverse, or alter the formation of rust or scale on various liquid contacting surfaces. Additionally, an electromagnetic signal at a frequency related to the energy absorption/emission characteristics of the liquid being treated is directed into the liquid.

U.S. Pat. No. 4,347,133 further discloses an electromagnetic ground water conditioning system and a sampling device comprising a holding tank, a pump, filters and timers to regulate the time and duration of blowout of settled solids at the bottom of the tank.

U.S. Pat. No. 4,365,975 further discloses a coal gasification operation or similar conversion process carried out in the presence of an alkali metal-containing catalyst wherein particles containing alkali metal residues are produced, alkali metal constituents are recovered from the particles by treating them with electromagnetic radiation. During the treatment step, the electromagnetic radiation facilitates the extraction of alkali metal constituents from the water-insoluble alkali metal compounds comprising the alkali metal residues. The resultant aqueous solution enriched in water-soluble alkali metal constituents is then separated from the particles depleted in alkali metal constituents and recycled to the gasification process where the alkali metal constituents serve as at least a portion of the alkali metal constituents which comprise the alkali metal-containing catalyst.

U.S. Pat. No. 4,407,719 further discloses a water treatment apparatus including a section of pipe arranged at the center of an electromagnetic force field created by a solenoid coil. A metal stationary rod is supported within the pipe and electrically insulated from the pipe such that water directed through the pipe passes by the rod. This rod is supported at both ends by insulated bearings secured within the pipe.

U.S. Pat. No. 3,511,776 discloses a method where electro-magnetic energy, mostly of a wavelength within the spectrum of ultra-violet light and X-rays, is radiated into water to make ions, which are susceptible to those wavelengths, and become responsive to the influence of a magnetic field. While the water is subject to the influence of this radiant energy, a magnet is used to separate the ions transversely of the cross section of the body of water, and water of different ion concentration is withdrawn for localized regions of the cross section.

In general, the methods and devices of the prior art utilize electromagnetic energy to bring about various effects on atomic or molecular matter contained in the fluid to be treated. One of the purported advantages of many such prior art electromagnetic devices is that they eliminate or reduce the need for the addition of chemical water treatment agents. However, many of the prior art methods and devices have proven to be only minimally or sporadically effective in certain applications.

A wide variety of devices has been proposed and developed for the purpose of treating fluids including water through the use of magnetic fields. Most of such devices are based on stagnant magnets, whereas only few are rotating, requiring contact with at least one rotating magnet within a vessel containing the liquid to be treated. A magnetic treatment device only requiring that the liquid to be treated be near the magnetic device was further proposed.

Document GB2047104A discloses an arrangement comprising a pair of rotating discs stacked on top of each other according to corresponding axes aligned with each other, wherein a plurality of electromagnets are arranged according to a regular outline around the circumference of the discs. It also discloses a method of treating water wherein the water is subjected to mechanical impacts having a minimum frequency of three impacts per 10th of a second by the moving (rotor) parts of a disintegrator.

US20060138891A1 discloses a device for healing or purification having magnets configured in a pattern confirming to sacred geometry, adapted for rotation about an axis. The device is useful for purifying water and breaking down toxic waste and environmental pollutants from the automobiles and industry in water, food, soil and air.

US20080296162A1 discloses a magnetic resonator which has a support structure and a plurality of roller assemblies mounted thereto for rotation about respective axes of rotation which are generally parallel one to another. The plurality of magnets is grouped in a plurality of first and second arrangements with a first arrangement being interspersed between a pair of second arrangements. At least one of the first and second arrangements incorporates a pattern or shape based on sacred geometry, yet only in quite general terms, in that this is merely alluded among equally likely several alternatives just like “pyramids” and the “Kathara grid”, or an equally likely option among a plurality of other generic exemplary selections further including “vesica pisces”, geometric arrangement of electromagnets in a pentagon (pentagram) is not developed, and even less in FIGS. 1 & 2 wherein only hexagonal arrangements are shown or claimed, but not pentagonal arrangements.

However, these known prior art devices and methods are, in many cases, confounded by technical complexity making such devices and methods expensive to manufacture and difficult to install.

In the devices proposed so far, it appeared that either the complexity of the device reached a level that is intended to be reduced, or the number of electromagnetic items or means was significant, whereas the aim of the present invention is to propose a device with a simplified construction, on the one hand, and that it is made compact, on the other hand.

### AIM OF THE INVENTION

Therefore, the present invention aims at overcoming the above stated shortcomings in the art by providing a versatile device for employing electromagnetic energy to treat water or various fluids for several applications, which are relatively simple.

### SUMMARY OF THE INVENTION

There is thus proposed according to the invention an apparatus as defined in claim 1, respectively apparatus for the electromagnetic treatment of a fluid comprising an electromagnetic radiation generator means for generating an electromagnetic signal s_{μ} with a customized spreading and distribution in space, wherein said electromagnetic radiation generator means comprises magnetic means as well as supporting means consisting of a circular plate constituted by a disc, which is rotatably arranged independently on an axis passing through its center. Said electromagnetic radiation generator means further comprises said magnet means in array arranged on said disc according to a circular pattern concentric about said axis, wherein said array is encompassed peripherally within the circumference of said first, resp. second disc. Said apparatus is remarkable in that said electromagnetic radiation generator means further comprises electric means including an array of coil means with a coil and magnet wiring means arranged with a predetermined location, and a pair of supporting means consisting of two mutually corresponding circular plates with an additional disc, wherein both said discs are positioned opposite to each other in parallel at a certain distance, and rotatably arranged independently on an axis passing through their centers thereby connecting them. The electric said array of coil means corresponds to the magnetic said array with the same number of electric coil, resp. magnet means, both in alignment therewith, arranged on said respective electric and magnetic discs according to a circular pattern concentric about said axis, wherein each said array is encompassed within the circumference of each of both said discs. Most remarkably, said coil and magnet means are both centered on each vertex of one regular quintuple polygon having a fivefold of vertices, in particular five, which are successively arranged equidistantly in said circular pattern. Said polygon may consist of a regular pentagon or any regular polygon having k times five vertices wherein k is an integer≥3.

A significant difference is that the apparatus according to the invention is based on the relationship between the arrangement of the magnet/coils and their wiring, i.e. the regular pentagon notably and the golden ratio φ. This relation is responsible for the unexpected, extraordinary results achieved thanks to the apparatus according to the invention.

The special arrangement on a disc defined as according to a selected pattern with their centers located on each vertex of a regular polygon, is not disclosed, in particular when having five vertices wherein the regular polygon is limited to the case having 5 vertices. The polygon is thus limited to a regular pentagon, or k×5. In this respect, in accordance with a preferred embodiment of the invention, there is provided an electromagnetic signal having a unique spreading and distribution in space, as well as a unique repetition symmetry, wherein the basic structure of such a device consists of two discs, and not one:
a) a first disc having 5 times k coils, where k is a natural number, constituting the electric side and
b) a second disc with counterparts of corresponding magnets oriented similarly as said coils, thus constituting the said magnetic side being physically distinct and separated from the former, thereby yielding all together said electromagnetic device.

In the ultimate background art references, it appears that an arrangement having 6 magnets in a circular pattern is actually disclosed therein as visible in Figs but not 5.

There is thus provided thanks to the present invention an electromagnetic fluid treatment apparatus which is relatively simple in construction and capable of being rapidly and efficiently manufactured. A quite simple construction of the apparatus is thus achieved, both in a considerably less amount of electric and magnetic items and with the simplified implantation mode thereof on one single circle line in the periphery of each disc.

The present invention thus provides an apparatus for treating fluids, preferably water, via a specific electromagnetic field for various applications, wherein there is remarkably proposed a specific coil and magnet wiring which is able to produce an electromagnetic field with unique spreading and distribution in space, as well as a unique repetition symmetry, leading to electromagnetically treated water or other fluids having exceptional benefits when applied in various applications. The technique noticeably includes the means of treating water or other fluids from an electromagnetic field, that is generated by a special connection of a 5-fold of coils, and a disc with counterparts of similarly oriented magnets quintuple as well. The generated electromagnetic radiation is unique in terms of spreading and distribution of electromagnetic field in space, as well as its repetition symmetry. These unique electromagnetic signal characteristics have been determined to provide optimal absorption and/or emission of energy by the targeted particular extraneous atomic and molecular matter present in the system.

For the exemplary case of k=1, the repetition symmetry of the electromagnetic radiation field generated with a single pentagon circuitry is equal to 4×π providing a repetition symmetry of 4×π in the illustrated case of k=1, especially for the electromagnetic treatment of water, having an incidence with regard to the unique character of the electromagnetic field produced with a particular spreading and distribution in space.

In this respect, the proposed device for the production of electromagnetic radiation according to a preferred embodiment of the invention, consists of a first disc having 5 or 15 or k times five, where k is a natural number of coils with centers on the vertices of a regular pentagon, or even any regular polygon having k times five vertices, possibly 10 for a regular decagon.

Said specific coil and magnet wiring produce an electromagnetic field having said customized spreading and distribution in space, as well as said repetition symmetry, which allow said electromagnetic treatment of said fluids after passing said liquid to be treated through a treatment channel arranged in said apparatus.

It is emphasized that the alleged ground for choosing said pentagon arrangement is associated to the golden ratio φ resp. the Fibonacci sequence for defining the relationship link between the said generated electromagnetic radiation signal s_{μ} and the irrational number of the golden ratio φ.

According to an advantageous embodiment of the apparatus according to the invention, said arrays of coil means, respectively magnet means are arrayed in one circular alignment on one single circle line on which all said coil means and magnet means respectively are arranged.

Said simplicity is thus further promoted by the specific arrangement of all coil and magnet means in said one circular alignment on one single circular line located in the neighborhood of the outer perimeter of each disc, which is in contrast with known devices where a plurality of magnets are disposed on a plurality of concentric circles.

According to a particular embodiment of the electromagnetic treatment apparatus according to the invention, the said electromagnetic radiation generator means is subdivided into two complementary portions of different nature, which are mutually cooperating and constitute a magnetic portion and an electric portion respectively, which are mutually separated by an interstitial gap ε extending planarly between both, wherein said electric portion and said magnetic portion are thus in a mutual juxtaposition. Said electric portion further comprises a one-dimensional array of coil means and said magnetic portion comprises a corresponding one-dimensional array of the same number of magnet means in alignment therewith. Both arrays are arranged on said respective pair of discs according to a circular pattern concentric about said axis [symbol] , wherein said one-dimensional arrays are encompassed within the circumference of said disc.

Said polygon consists of a regular pentagon or any regular polygon having k times five vertices wherein k is an integer≥3, wherein said generated electromagnetic radiation signal (sμ) is related to the so-called golden ratio φ, defining the geometric proportion of the regular pentagon, wherein

$$φ = \frac{1 + \sqrt{5}}{2} ∼ 1 , 618.$$

A connection between the arrangement of the coils/magnets and their wiring, i.e. the regular pentagon, is thus made with the gold ratio φ. Technically, the pentagram has a special number hidden inside it corresponding again to said golden ratio φ. In general, two quantities a and b (with a>b) are considered to follow the golden ratio, if the ratio of their sum (a+b) to the largest quantity a is equal to the ratio of the largest quantity a to the smallest b, that is (a+b)/a=a/b=φ. In this context, several characteristic length ratios of said pentagram yield said golden ratio commonly represented by φ, such as (a+b)/a=a/b.

Also the mutual arrangement of the electric items consisting of electric coils and the magnets in a mutual alignment, i.e. without interpenetrating each other, thereby belonging to spatially separated areas for the electric side containing the electric coils and the magnetic side containing the magnets, which are set-up with a mutual interstitial gap forming a planar extending space between both sides electric and magnetic. Thanks to this separation gap between the electric and magnetic sides, both discs—electric and magnetic—may mutually rotate with less risk of mutual contact and damage. Thanks to the smoother arrangement of the electromagnetic fluid treatment apparatus into two physically different entities each constituting functionally different portions of the apparatus yet actively closely cooperating with each other, wherein both functional parts A, B are separated from each other by means of an interstitial gap between both parts extending according to a virtual plane between both parts A and B without mechanical interaction between both, there is less risk of damage in case of disturbance or maladjustment or dysfunction of any kind. This is also an advantage obtained thanks to the invention resulting from the versatility and high degree of simplicity of construction, notably promoted by a physical separation between the electric part A and magnetic part B of the device, instead of mutually interpenetrating components and items.

According to an advantageous embodiment of the invention, the coils are assembled in series, with each coil being connected with the coil located in the immediately opposite direction according to a corresponding diagonal of a to corresponding pentagram, thereby obtaining a specific distribution symmetry of the formed power with a maximum power. The power of electromagnetic radiation mainly depends on the relative angular velocity of the two discs, the characteristics of the magnets and coils, as well as on the distance between said coils and magnets. Likewise, said power may thus be regulated by setting the parameters of said characteristics through said relative angular velocity of both discs.

Thanks to the present invention, the electromagnetic radiation produced by the proposed system is specific in symmetry and distribution, while the generated frequency and the power depend on the relative angular velocity of the two discs.

The proposed system thus generates an electromagnetic radiation field that shows a unique spreading and distribution in space, which is directly dependent on the coil-magnet location and wiring, wherein the electromagnetic radiation generator comprises a combination of five coils arranged mutually equidistantly on said first disc and a corresponding equal number of magnets in alignment therewith arranged according to the vertices of a regular polygon, wherein said polygon consists of a pentagon, decagon or any regular polygon having k times five vertices, wherein k is an integer.

In a further preferred embodiment of the present invention, the 5-fold set of coils is connected in series as a regular pentagram, with said coils located at each vertex of said pentagram, wherein said pentagram has the appearance of a 5-pointed star. Said star-shaped crossing connection pattern, is not disclosed whatsoever in the prior art. It further shows remarkably that inside the pentagram is a pentagon referred to above. Now, the pentagram has a special number hidden inside it, corresponding again to said golden ratio φ as well. Several characteristic length ratios of said pentagram yield said golden ratio, such as representative characteristic sides ratios a/b=b/c=c/d. Said golden ratio φ appears quite often in geometry, art, architecture, and design. Several artists, architects and designers believe that the golden ratio produces the most harmonious shape. Accordingly, many buildings, art and design works have the golden ratio in them. The coil means are thus mutually connected in series as a regular pentagram, with said coil means located at each vertex of said pentagram, wherein said coil means are arranged at the five tips respectively of said pentagram, and in that each coil means is connected to the pair of non-adjacent coil means located opposite according to a star-shaped crossing connection pattern, wherein the connecting sections cross each other.

According to a further embodiment of the present invention, each coil is connected with the coils located opposite in a star-shaped crossing connection pattern, wherein the connecting sections cross each other thereby forming floating virtual off-circuits within the coil polygon, respectively disc perimeter. In addition, based upon the abovementioned property of the golden ratio φ that it equals the ratio between a diagonal of a pentagon and a side thereof, this was a clue to arrange a connection set-up of coils according to a pentagon according to the invention.

Spirals could be observed on many natural objects that form helices, whereas the number of helices is closely related to the related Fibonacci sequence, such as with the seeds of a sunflower which form helices in a spiral like the pinecone. On the ground why the efficiency issue for such geometrical arrangements should be considered, notably for enhancing the growing process of plants and the optimization of filling up the space available, inspiration was pointedly found therein to transpose this process to the present invention by addressing the issue whether this geometrical esthetics in plants could have any special effect on the behavior on an electromagnetic radiation signal being generated and distributed in space by establishing a relationship with the golden ratio φ or the Fibonacci sequence respectively. This transposition is based upon the statement that said golden ratio φ is fundament of the geometric proportion of the regular pentagon—or any regular polygon having k times 5 vertices wherein k is an integer—. As a matter of fact, it could be established according to the invention that the electromagnetic radiation field thus generated has a unique repetition symmetry indeed, wherein an electromagnetic field is produced with a customized spreading and distribution in space as well as a repetition symmetry, which is determined by said remarkable coil—magnet location and wiring according to the invention. So, said reference to harmony is also associated to nature, wherein features based upon Fibonacci sequence and golden ratio are often found. In certain objects of nature, spirals can be observed involving said golden ratio. So, does the so-called gold spiral, which is encompassed in a rectangle, the proportions whereof correspond to the golden ratio based upon all these special properties thereof, both in nature but also in art and design especially in relation to harmony, in association with the special relationship thereof with Fibonacci numbers. All this background was taken as an incentive to be transposed to the electromagnetic radiation wave being generated and distributed in space as well as its repetition symmetry, thus founding the special feature of the generated electromagnetic radiation originating from the apparatus proposed according to the invention.

The basis of the transposition set out above, was further drawn from the observation that a similar transposition interpretation is currently accomplished in a totally different field of finance in the technical analysis of financial markets where a so-called tool of Fibonacci retracement is commonly practiced.

Back to nature again, more particularly with regard to the leaves of plants referred to above, it was established that the leaves of a plant also develop according to spiral to fulfill various functions with the aim to enhance protection of all the leaves of the plant or to optimize its arrangement for optimizing rainwater adduction, all this again thanks to a suitable spiral arrangement of the leaves.

What is most interesting about the Fibonacci sequence is that its pattern of growth appears to match the forces controlling growth in a large variety of natural dynamical systems. A famous example of the occurrence of the Fibonacci sequence in nature is found in a variety of trees and flowers, generally associated with some kind of spiral structure. For instance, leaves on the stem of a flower or a branch of a tree often grow in a helical pattern, spiraling around the branch as new leaves form further out. When focusing on a given leaf and starting to count around and outwards, counting leaves and also counting the number of turns around the branch, until getting back to a position matching the original leaf but further along the branch result in that both numbers will be a couple of mutually following Fibonacci numbers.

Pinecones are also constructed in a spiral fashion, small ones having commonly with 8 spirals one way and 13 the other. The most interesting is the pineapple built from adjacent hexagons, three kinds of spirals appear in three dimensions: there are 8 to the right, 13 to the left and 21 vertically—a Fibonacci triple. Nature thus found an evolutionary advantage in arranging plant structures in spiral shapes exhibiting the Fibonacci sequence. A mathematical demonstration was provided that the helical arrangement of leaves on a branch in Fibonacci proportions was an efficient way to gather a maximum amount of sunlight with a few leaves.

In terms of natural growth patterns, the presence of spirals and the connection between spirals and the Fibonacci sequence is to be understood, where spirals arise from a property of growth called self-similarity or scaling, including the tendency to grow in size but to maintain the same shape. When further referring to the Fibonacci sequence, a special spiral is obtained, the so-called sunflower spiral, which is a self-similar curve keeping its shape at all scales. It is called equiangular because a regular line from the center makes always the same angle to the curve, which was already known to Archimedes, the greatest geometer of ancient times. When considering the Fibonacci sequence, the proportions of adjacent terms of the sequence begin to approach a fixed limiting value of 1,618 which, in turn, is a famous ratio, the golden mean of Aristotle, also called the divine proportion of Da Vinci. Its tantalizing properties illustrated by the wide variety of applications set out above, led to a reasoned choice of this ratio especially in association with the geometric shape it is related to, the pentagon, or also decagon, or other regular polygons based on 5-fold sides.

This golden ratio is thus used as a foundation of the 5-fold structures incorporated in the apparatus according to the invention for yielding the electromagnetic signal with its unique radiation pattern.

In short, the technical effect obtained thanks to said selected pattern of an electromagnetic radiation generating means based on a regular pentagon arrangement, consists of an electromagnetic radiation signal being generated by means thereof that is intrinsically related to the golden ratio which is part of the geometric proportion of the regular pentagon as an irrational number. Said generated electromagnetic radiation field has a repetition symmetry corresponding to 4×k×π, wherein π is another irrational number again, thereby yielding a unique spreading and distribution in space of said produced electromagnetic field, as well as a unique repetition symmetry thereof which revealed to be efficient in the electromagnetic treatment of fluids.

This is the key in that this establishes that a technical solution was brought to the technical problem of providing an efficient electromagnetic treatment of fluids by means of an adequate choice of circuitry arrangement according to the invention.

According to a more particular embodiment of the present invention, said arrays of coil means, respectively magnet means are arrayed in one circular alignment on one single circle line on which all said coil means and magnet means are arranged respectively.

The specific pentagonal arrangement allows a compact structure based on a reduced number of electromagnetic means divided into an electric side with the electric coils and a magnetic side with corresponding magnets respectively. In a basic embodiment, said amount<6, actually 5 on each disc, electric and magnetic.

According to a still more particular embodiment of the invention, said magnet means have a substantially cylindric shape protruding from said magnetic disc over a height with the top directed to the coils so as to leave a small gap ε between said coils and magnet means when mounted, so as to allow free relative movement between both said first and second discs.

According to a yet more particular embodiment of the invention, the magnetic array is composed of mutually unconnected magnetic means.

According to a specific embodiment of this type, a regulating means is placed on top of said electromagnetic radiation generator device on its outer surface, for allowing a passage of said fluid therein through an input.

Thanks to this advantageous embodiment of the invention, the water to be treated does not have to pass between the rotating discs, but instead said fluid to be treated may remain outside of the device. This constitutes an advantage for the maintenance of the device, thereby also avoiding any premature wear thereof thanks to the avoidance of contact between the fluid to be treated and inner components of the device, in contrast with the closest prior art. Likewise with the other dynamic arrangement including a separate regulating means by means whereof the fluid to be treated only passes in this specifically added regulating means which is kept outside the electromagnetic device and components as such.

According to a further embodiment of the apparatus of the invention, said regulating means incorporates an extended pathway for the flow of the incoming fluid to be treated, wherein said pathway has a spiral like shape preferably with substantially constant section, in particular circular or hemi-circular, starting from said input to evolve as circular windings in progress with further windings downsizing to the center of the top surface of said regulating means constituting the output of said regulating means from which said flow of the fluid leaves said electromagnetic radiation generator apparatus after having been treated in it. According to this more specific embodiment of the device, the browsed traject for the flow of fluid to be treated is optimized by maximizing the pathway in the treatment device, in addition with a fairly smooth passage thanks to the steadily progressing browsing, all in curves, right after the input, up to the output, all way long. Thanks to an optimally extended pathway, the exposure time t of the fluid flow to said electromagnetic radiation is considerably increased, thus making the efficiency of the treatment substantially increased as well accordingly. According to a further embodiment of the apparatus of the invention, said fluid (spiral) pathway is arranged on the outer surface, particularly on its top surface.

According to a handy embodiment of the invention, it comprises a frame wherein said electromagnetic radiation generator device is mounted, with said electric coils and magnet means being disposed with said interstitial gap ε inbetween, particularly wherein it is provided with setting means. It is thus portable, wherein it is compact with overall dimensions being limited and with a limited maximum weight.

According to a basic embodiment of a first type variant of said apparatus according to the invention, said generator further comprises driving means for mutually rotating said discs, which are mutually independent for rotating said discs independently, wherein the relative rotation is generated by electric motors, which are controlled by an electronic rotation control device. Said coil and magnet wiring produce an electromagnetic field with a customized spreading and distribution in space, which is determined by said remote coil-magnet location and wiring, as well as a repetition symmetry, which allow said electromagnetic treatment of said fluids after passing said liquid(s) to be treated through a treatment channel arranged in said electromagnetic radiation generator device. This invention thus provides an electromagnetic fluid treatment apparatus, notably water, wherein said fluid is treated by an electromagnetic signal having a unique spreading and distribution in space, as well as a unique repetition symmetry. These unique electromagnetic signal characteristics have been determined to provide optimal absorption and/or emission of energy by the targeted particular atomic and molecular extraneous matter present in the system, esp. in the liquid to be treated.

Thanks to the present invention, the generated electromagnetic radiation field shows a unique repetition symmetry, which is 4kπ—where k is a natural number—and it is directly dependent on the coil-magnet location and wiring, as well as of an irrational number π. The special feature of the electromagnetic radiation generated by the proposed device is its specific diffusion and remarkable distribution in space, as well as its repetition symmetry, being 4*kπ. The way in which the electromagnetic radiation wave is typically generated and distributed in space is outstandingly related to the most important irrational number found in nature, which is the golden ratio commonly represented by φ, which cannot be expressed as a fraction and which exist notably in the well-known geometric proportion of the regular pentagon or the Fibonacci sequence number.

This statement notably resulted to select this specific shape of this particular layout with a pentagonal pattern of coils and magnets wiring or a regular polygon having k times five vertices thanks to the present invention.

The relationship between the golden number and the specific geometry of the regular pentagon is given by the ratio between a diagonal of the pentagon and one of its sides. Likewise, there is also such a geometrical relationship between a regular decapentagon and said golden number which is given between the ratio between the radius of the encompassing circle and one of its 15 identical sides. Accordingly, the various coils arranged as a pentagon are mutually connected along the diagonals of the pentagon, thus providing the aforementioned specific effect making the generated electromagnetic radiation so unique in terms of spreading and distribution of electromagnetic field in space, as well as its repetition symmetry.

According to a still further embodiment of the present invention, at least one of said magnets—or all—, are constructed from neodymium or other compound(s), or a mixture of compounds, provided that it results in a similar strength. Advantages of such neodymium magnets include high resistance to demagnetization and better power to weight ratio.

According to a more particular embodiment of the present invention, the relative rotational motion of the two discs in the proposed device produces a unique electromagnetic radiation, the frequency of which depends on the relative angular velocity of the two discs, wherein said frequency can thus be determined by said relative angular velocity, which is directly controllable by the user.

As set out more in detail below, the external application of an electromagnetic field brings about various disruptions of the internal fields which are responsible for the particular atomic or molecular structure and the interrelationships of the charged particles therein. It was observed yet that electromagnetic treatment of fluids affects the behavior of inorganic and organic materials in it, including crystallization and biological processes. By electromagnetizing water or other fluids, molecules line up in a “+−+−” sequence. This process changes fluid's properties, such as by reducing its surface tension and viscosity, increasing dissolvability, increasing permeability and oxygen content, etc. Thus, depending upon the atomic or molecular matter present, the energy absorption/emission characteristics of a solution will depend on the frequency of the external electromagnetic field applied.

According to another embodiment of the apparatus of the invention, said magnetic disc along with their wiring of the coil means resp. disc are provided with a set of passing means arranged therein consisting of shaped apertures for allowing a passage therethrough for said fluid. In this respect, it is to be represented that the triangular section of the apertures of said first disc is slightly reduced from the inner surface of said first disc to its outer surface, contrarily to the second disc wherein the apertures have a substantially constant section. This downsizing of the first disc apertures has an impact on the fluid flow entering the electromagnetic radiation generator device by first passing through said second magnetic disc and subsequently the first disc, whereas the rotation of the latter is automatically figured by the flow of said incoming fluid, which is channeled through said electromagnetic radiation generator device.

The energy required to rotate said first disc is drawn from the kinetic energy Eₖᵢₙ of the incoming fluid to be treated, as it passes through said apertures that are properly shaped to this end, thereby depending on its viscosity.

According to a further embodiment of the apparatus of the invention, said apertures have a prismatic shape, in particular with a triangular section with top oriented to the center of the disc.

According to a still further embodiment of the apparatus of the invention, said apertures are arranged between successive electric coils, and respectively magnet means in the respective first and second discs, thereby extending radially from the disc perimeter to its center.

According to a yet further embodiment of the apparatus of the invention, the section of the apertures may vary between the inner surface of the first disc and the outer surface thereof.

According to a yet further embodiment of the apparatus of the invention, said coil wiring is incorporated on the outer surface of the first coil disc, whereas the coils are incorporated at the inner side thereof; and said magnet means are incorporated on the inner side of said second disc for actively cooperating with said coil means.

The present invention also relates to a method of electromagnetic treatment of fluids, particularly water, for carrying out an apparatus as defined above, wherein an electromagnetic treatment method for water or other fluids is proposed, wherein an electromagnetic signal s_{μ} is generated with a targeted spreading and distribution in space by an electromagnetic radiation generator means, wherein electromagnetic means including a coil and magnet wiring means arranged in a regular pentagon or any regular polygon having k times-five vertices, wherein k is an integer≥3, on respective first and second discs independently rotatable on an axis [symbol] , wherein said method comprises the steps of:
a) generating an electromagnetic signal, and
b) passing the untreated fluid(s) such as water through the said electromagnetic signal, and remarkably as well the steps of:
generating an electromagnetic signal by mutually rotating both said discs each with their angular velocities resp., wherein the relative angular velocity of the relative rotational motion of the two discs produces said targeted electromagnetic radiation, the frequency of which depends on the relative angular velocity of the two discs and
passing said untreated fluid through the electromagnetic signal,
   wherein the relative rotational motion of the two discs produces said targeted electromagnetic radiation, the frequency of which depends on the relative angular velocity of the two discs, particularly wherein the electromagnetic radiation field has a repetition symmetry for every 4π, in that said electromagnetic radiation field is repeated every 4π.

This invention thus also provides an electromagnetic treatment method of fluids, notably water, wherein said fluid is treated by an electromagnetic signal having a unique spreading and distribution in space, as well as a unique repetition symmetry. These unique electromagnetic signal characteristics have been determined to provide an optimal absorption and/or emission of energy by the particular atomic and molecular matter present in the system.

According to a particular embodiment of the method according to the invention, the frequency of the external electromagnetic field applied is established and the energy absorption/emission characteristics of a solution formed by said fluid is determined depending on the targeted exogenous atomic or molecular matter present in said fluid.

According to a more particular embodiment of the invention, the relative rotation of said discs in said apparatus is generated by generator means particularly electric motors respectively, which are controlled by control means, particularly electronic rotation control devices.

According to a preferred embodiment of the invention, the flow of said fluid is selected, whereas the rotation of said first disc is automatically triggered by the flow of said fluid, which is channeled through said electromagnetic radiation generator device to start from its said top, wherein the energy required to rotate said first disc is drawn from the kinetic energy Eₖᵢₙ, of the incoming fluid to be treated, as it passes through said shaped apertures, depending on its viscosity η.

According to a further preferred application of the invention, an electromagnetic energy is thus used for the treatment of said fluid in the growth of bean seeds, wherein the bean seeds are watered regularly, more particularly daily, both with a small amount of said electromagnetically treated water referred to as φ-water, i.e. water treated with a “φ-device” i.e. including a pentagon array, and with the same amount of not electromagnetically treated water, yielding beans being subjected to said electromagnetically treated water having at least 25% greater growth rate for several days compared to that of seeds watered with the same amount of said untreated water.

According to an additional application of the invention, said apparatus is used wherein a container, notably of bottle-type, containing fluid is placed on the upper outer surface of the fluid treatment device containing said electromagnetic radiation generator, wherein said container with said fluid is then exposed to the generated electromagnetic radiation s_{μ} thereby improving its efficiency.

Ready-packed products belonging to the set formed by pharmaceuticals, cosmetics, respectively and health care products containing said fluid, are placed on the upper surface of the fluid treatment containing said electromagnetic radiation generator, wherein said products and especially said fluid are then exposed to the generated electromagnetic radiation s_{μ} for improving its efficiency.

In a further embodiment of said method according to the invention, the power of the electromagnetic radiation to be generated for the targeted fluid(s) treatment is set by calculating the same from a combination of parameters determined by the relative angular velocity of the two discs, the characteristics of the magnets and coils, as well as on the distance between said coils and magnets, on which the said power depends.

In a still further embodiment of said method according to the invention, electromagnetic radiation is produced from the proposed elemental configuration when carrying out the relative rotational motion of discs, wherein said electromagnetic radiation is generated, the frequency whereof is determined by said relative angular velocity Δω of the two discs, wherein the power of electromagnetic radiation depends mainly on the relative angular velocity of the two discs, the characteristics of the magnets—coils and the distance between the coils—magnets.

In a yet further embodiment II of said method according to the invention based on the operating principle of the proposed device as defined above, the flow of said fluid is selected, whereas the rotation of said first disc is automatically triggered by the selected flow of said fluid(s), which is channeled through its structure to start from its said top, wherein the energy required to rotate said first disc is derived from the kinetic energy of the liquid, as it passes through said properly shaped holes, depending on its viscosity.

According to a specific embodiment of said method,
said liquid to be treated is selected as an aqueous solution,
which is prepared with a nutrient medium,
a positive effect of electromagnetic irradiation of said preparation of aqueous solution with the nutrient medium is generated before inoculation with cells, in particular Chlorella vulgaris, on the basis of the culture growth curves,
wherein said positive effect of the irradiated water referred to herein as ϕ-water (by reference to the golden ratio φ) results in an additional increase in biomass production of about 15% -20% compared to the control cultures in which untreated water (c-water) is used.

Another aspect of the present invention consists of the use of a convenient method and system for utilizing electromagnetic energy for the treatment of water or other fluids, for several purposes such as farming and agricultural and industrial applications, environmental and household uses, mammal health and cattle-breeding, cosmetics, pharmaceuticals and others.

To summarize, in accordance with a typical aspect of the present invention, an electromagnetic treatment method for fluids is thus proposed, said method comprising the steps of:
a) generating an electromagnetic signal, and
b) passing the untreated water or other fluids through the said electromagnetic signal. Thanks to said method, suitably treated fluids are achieved with exceptional benefits when applied in various applications.

Thanks to the invention, a broader utility is thus achieved and it may be used in a variety of applications including virtually any application wherein electromagnetic energy is used for water or other fluids treatment, such as farming and agricultural applications, industrial applications, i.e. reduction—or even elimination—of scaling salts and corrosion in industrial water facilitating systems, environmental and household uses, such as in sewage systems and in restoring house plumbing, mammal health and cattle-breeding, cosmetics, pharmaceuticals and others. Outstandingly, the utilization of the proposed electromagnetic treatment method of liquid, notably water or water solution/suspensions, and the associated apparatus incorporating the unique spreading and distribution of electromagnetic field in space, as well as its unique repetition symmetry, brings a significant improvement in several fields of applications.

Additional features and advantages of the invention will become apparent to those skilled in the art upon consideration of the further subclaims and/or the accompanying drawings as well as the detailed description and examples which follow.

### BRIEF DESCRIPTION OF THE DRAWINGS

FIG. 1a shows schematically the configuration of a first basic elemental of a device proposed according to the invention consisting of a first disc including the coil structure and wiring.

FIG. 1b shows the configuration of a further basic elemental of said device proposed according to the invention consisting of a complementary disc including an equal number of magnets.

FIG. 2 shows schematically the combined configuration of both elements shown in FIGS. 1 & 2 for a device according to the invention including a pentagram arrangement of the coil writing structure.

FIGS. 3a & 3b show schematically the configuration of said first & second elements shown in FIGS. 1 & 2 as such, i.e. without said discs but including structure and wiring.

FIGS. 4a & 4b show schematically said first & second elements shown in FIGS. 1 & 2, resp. 3a & 3b as such individually, i.e. without said wiring but including structure.

FIGS. 5a, 5b & 6 show similar views of the configuration of said basic elements of the device according to the invention as in FIG. 1a, 1b and 2 resp, as constructed for the real device.

FIG. 7 shows the combined configuration of both elements shown in said FIGS. 5a, 5b & 6 for said device according to the invention.

FIG. 8 shows said combined configuration shown in said FIG. 7 incorporated in a suspended frame for said device according to the invention.

FIG. 9 shows an electromagnetic treatment apparatus of Type A according to the invention incorporating said frame with device shown in said FIG. 8.

FIGS. 10a and 10b show an electromagnetic dynamic static treatment apparatus according to the invention shown in said FIG. 9 in a static use for different specific applications.

FIG. 11 a shows an electromagnetic treatment apparatus according to the invention shown in said FIG. 9 in use for a dynamic variant of continuous flow application.

FIG. 11b shows an essential component individually for said dynamic treatment apparatus according to the invention shown in said FIG. 11a.

FIG. 12a shows an alternative arrangement of a second basic device, of Type B configuration device of the invention.

FIGS. 12b to 12d show an essential component individually for said electromagnetic treatment apparatus according to the invention shown in FIG. 12a.

FIG. 13 shows a graphic diagram representing the effect of the method according to the invention.

FIG. 14 shows experimental representations in use for a specific application in support of the effect of the method according to the invention.

FIG. 15 shows a schematic representation of the golden ratio estimation in a regular pentagon along with a representation of the electromagnetic radiation signal vector within the wiring circuitry arrangement according to the invention.

### DESCRIPTION

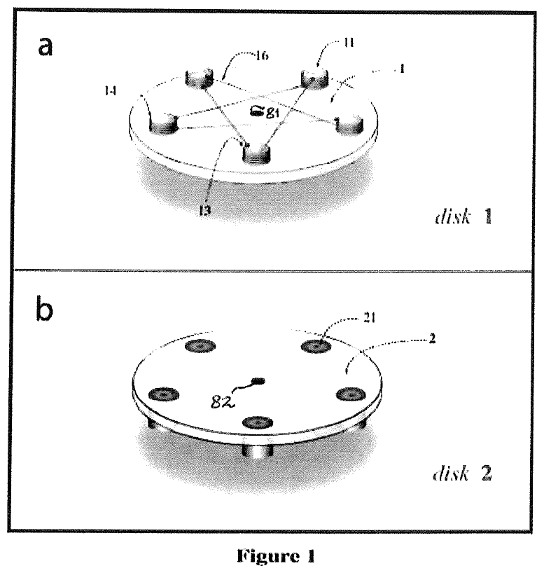

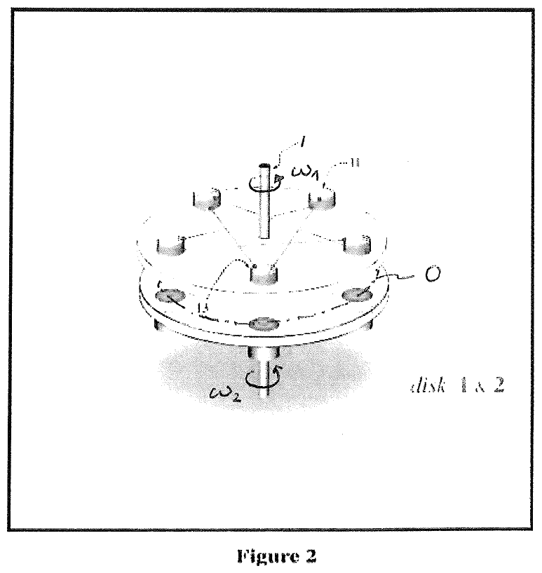

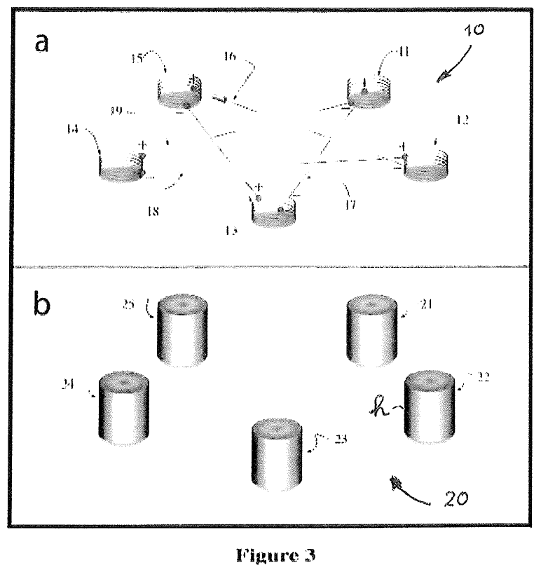

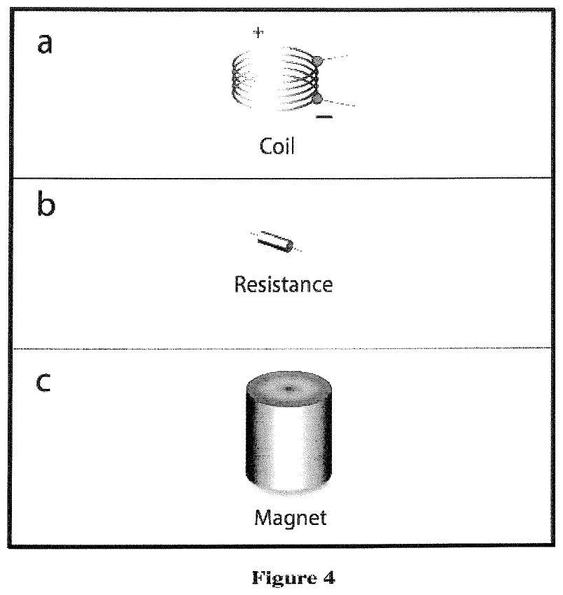

The main embodiment of an apparatus, resp. method according to the invention is referred to herein as the best mode for carrying out the invention with reference to the drawings. An elemental configuration of the proposed apparatus for the production of electromagnetic radiation is set out hereafter, wherein said configuration of the proposed device is shown in FIG. 2 consisting of a first disc 1 supporting five coils as shown in FIG. 1 a with their centers located on the vertices of a regular pentagon. The wiring 16 of the coils in disc 1 is in series, as shown in FIG. 1. Each coil 11, 12, 13, 14 and 15 is connected in series with its immediate opposite 1-1 pair of coils, as shown schematically with a corresponding pentagram representation wherein each coil is located at each top of said pentagram in FIG. 3a, wherein the 5 fold set of coils is connected in series as a pentagram, with said coils located at each vertex of said regular pentagram.

A second disc 2 supports a corresponding number of magnets 21, 22, 23, 24 and 25 as shown in detail in FIG. 1b, which are oriented similarly to the coils 11, 12, 13, 14 and 15 in parallel with said main axis [symbol] as shown in FIG. 2.

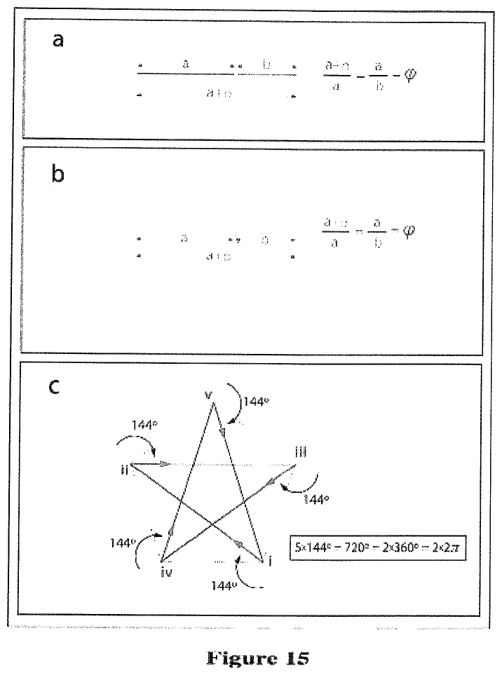

Said pentagram is shown in detail in FIG. 15, having the appearance of a 5-pointed star. It further shows that inside the pentagram is a pentagon referred to above. The pentagram has a special number hidden inside it corresponding again to the golden ratio, commonly represented by φ, which equals approximately 1,618. In general, two quantities a and b (with a>b) are considered to follow the golden ratio, if the ratio of their sum (a+b) to the largest quantity a is equal to the ratio of the largest quantity a to the smallest b, that is (a+b)/a=a/b=φ as shown in FIG. 15a. In this context, several characteristic length ratios of said pentagram yield said golden ratio commonly represented by φ, such as (a+b)/a=a/b as represented in FIG. 15b. The golden ratio is considered by many architects, designers and artists to produce the most harmonious shape. Accordingly, said golden ratio appears everywhere in the geometric proportions of the universe, from the microcosm to the galaxies and it has been applied in many fields such as geometry, architecture, design and art.

Said reference to harmony is also associated to nature, wherein features based upon golden ratio but also Fibonacci sequence, are often found. In general, the Fibonacci sequence has as its first two terms 0 and 1, and each subsequent term results from the sum of its two previous terms, such as 0, 1, 1, 2, 3, 5, 8, 13, 21, 34, 55, 89, 144, 233, 377 . . . . The golden ratio number φ is the limit of the ratio of the n^{th} term of the Fibonacci sequence to its (n-1) terms, with n^{th} term tending to infinity. In certain objects of nature, spirals can be observed involving said golden ratio. So does the so-called gold spiral which is encompassed in a rectangle, the proportions whereof correspond to the golden ratio based upon all these special properties thereof, both in nature but also in geometry, architecture, art and design, especially in relation to harmony, in association with the special relationship thereof with Fibonacci numbers. All this background was taken as an incentive to transpose to the electromagnetic radiation wave being generated and distributed in space, as well as its repetition symmetry, thus founding the special feature of the generated electromagnetic radiation originating from the apparatus according to the invention.

The basis of the above-mentioned transposition as set out above, was further drawn from the observation that a similar transposition and interpretation is currently accomplished in a totally different field of finance in the technical analysis of financial markets where a so-called tool of Fibonacci retracement is commonly practiced.

Back to nature again, more particularly with regard to the leaves of plants referred to in the background section, it was established that the leaves of a plant also develop according to a spiral to fulfill various functions with the aim of enhancing protection of all the leaves of the plant or to optimize its arrangement for optimizing rainwater adduction, all this again thanks to a suitable spiral arrangement of the leaves.

Based upon the above-mentioned property of the golden ratio φ that it equals the ratio between a diagonal of a pentagon and a side thereof, this was a basis to arrange a connection set-up of coils arranged according to a pentagon according to the invention.

This may be realized using the geometric shape of the regular pentagon, shown in FIG. 15b, where its diagonals intersect in sections that have a ratio equal to the golden ratio. When a vector quantity, such as the electromagnetic radiation signal s_{μ}, passes through the pentagram in order to return to its original position as shown in FIG. 15c, it must be rotated by a total of 5×144° which is equal to 720° , i.e. in two cycles of 2×360° or else 2×2kπ=4kπ. Hence, in this way, the electromagnetic radiation signal repetition symmetry generated from a regular pentagram i.e. 4*kπ is interrelated with the most important irregular number found in nature, i.e. the golden ratio φ.

To summarize, this golden ratio is thus used as a foundation of the 5-fold structures incorporated in the apparatus according to the invention for yielding the electromagnetic signal with its unique radiation pattern and repetition symmetry, in that it has shown to be surprisingly efficient in several applications set out hereafter. Likewise for regular quintuple polygons with 15 . . . or even more k times five, were k is a natural number or possible 10 for any regular polygon having k times five vertices, respectively.

Said magnets 21, 22, 23, 24 and 25 are advantageously made—at least in part—from neodymium due to its higher strength.

The production of electromagnetic radiation from a first proposed elemental configuration is set out hereafter. In the elemental arrangement of the apparatus, said first and second discs 1, 2 are positioned opposite to each other mutually parallel at a short distance d and they are rotated independently on the same axis [symbol] passing through their respective centers, as shown in FIG. 2. When said first and second discs 1, resp. 2, are mutually rotated causing a relative rotational motion thereof, an electromagnetic radiation is generated, the frequency v of which depends on the relative angular velocity Δω=ω1−ω2 of the two discs 1, 2. The power of electromagnetic radiation depends mainly on the relative angular velocity of the two discs, the characteristics of the magnets-coils and the distance between the coils-magnets.

The special feature of the electromagnetic radiation generated by the proposed device resides in its specific diffusion and particular distribution in space, as well as its remarkable repetition symmetry, which is 4*kπ wherein k is a natural number, 1 in the case considered as represented in FIG. 1 and following. The way in which the electromagnetic radiation wave is typically generated and distributed in space is especially related to the most important irrational number found in nature that is the golden ratio number φ, which exist in the geometric proportion of the regular pentagon shown in FIG. 3a, resp. 3b, or the Fibonacci sequence respectively.

Accordingly, the following integrated devices are proposed based on the above described elemental configuration, wherein two different configurations of devices 100, 110 are proposed depending on the applications in which they are to be used and their integration into the corresponding industrial production line. This allows to use the most suitable configuration among both types available 100 or 110 respectively.

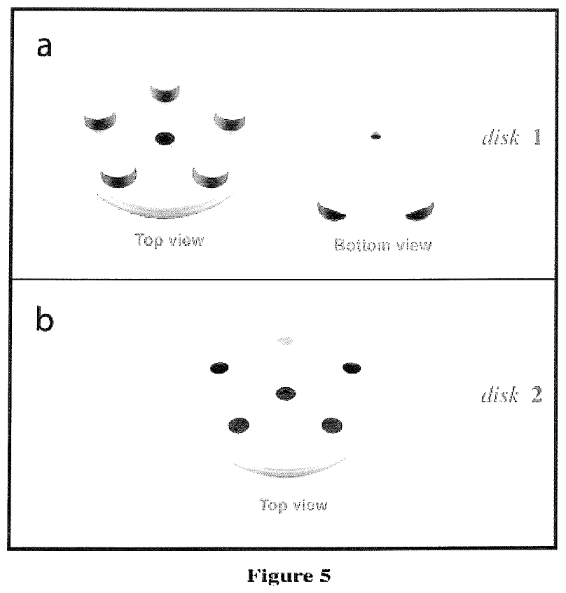

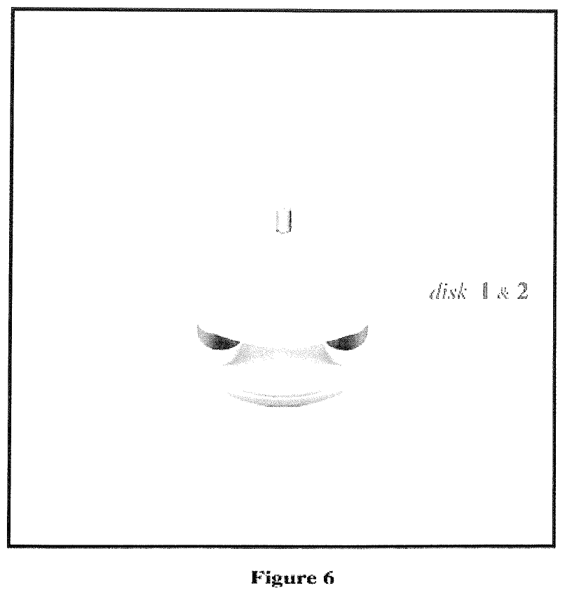

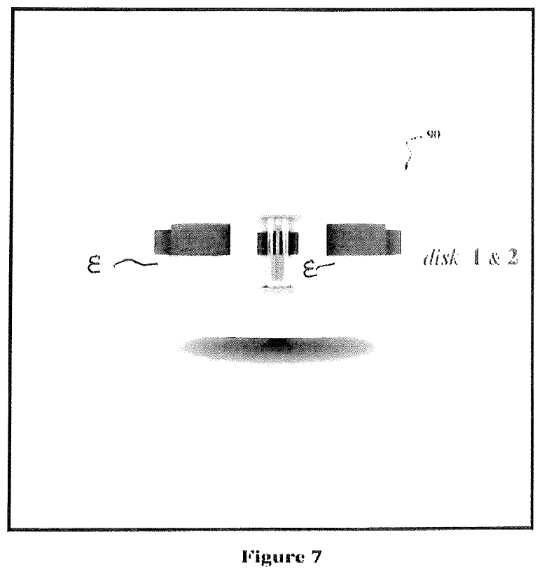

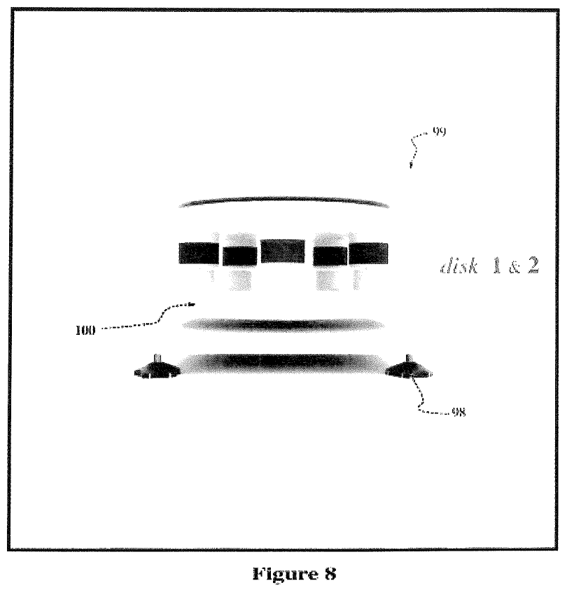

A first type of devices is based on the elemental arrangement shown in FIG. 7 including said discs 1, 2, which are formed with the combination of e.g. five coils 11, 12, 13, 14 and 15 and an equal number of magnets 21, 22, 23, 24 and 25. FIGS. 5a & 5b show schematically said discs 1, 2, their combination in FIG. 6, as well as their arrangement in the proposed type of electromagnetic radiation generator 90 in FIG. 7. The relative rotation of said discs in this class of devices is generated by electric motors 51, 52 which are controlled by electronic rotation control devices 55, shown in FIG. 9.

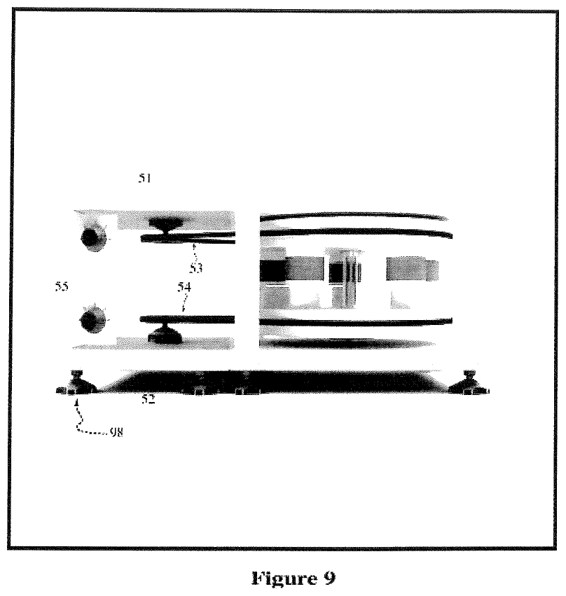

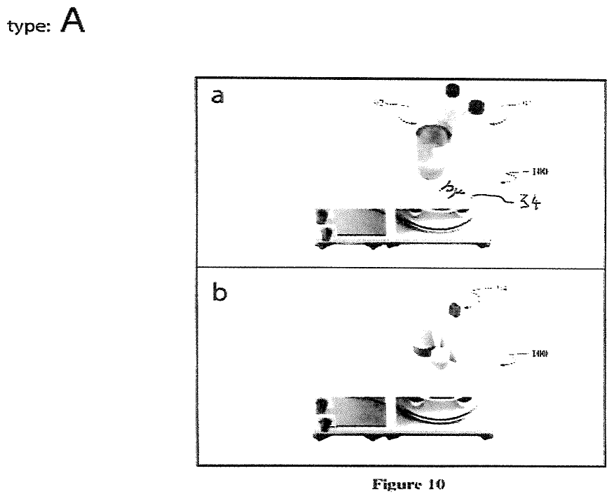

This first type of devices 100 may be used in two ways: with suitable containers 91, 92 including the fluid therein, such as water or with ready-packed products containing said fluid(s), which are placed on the upper surface 39 of the device 100 in a static position. The product, especially the fluid, is then exposed to the generated electromagnetic radiation as shown in FIG. 10.

A special component 30 designated as a of the apparatus is shown in FIG. 11b. It is placed on top of the proposed structure, in which the fluid is passed through as shown in FIG. 11a. In this case the dynamic exposure of fluid in the generated electromagnetic radiation is regulated by the selected flow of fluid. The exposure time, hence, is dependent on the selected fluid flow rate, and can be regulated by varying the input fluid flow rate.

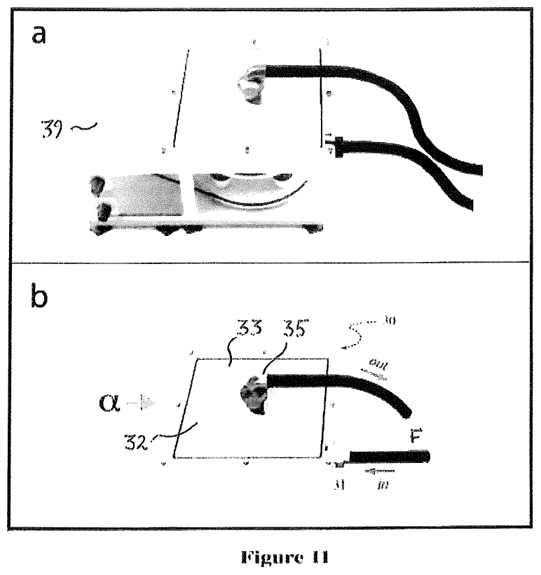

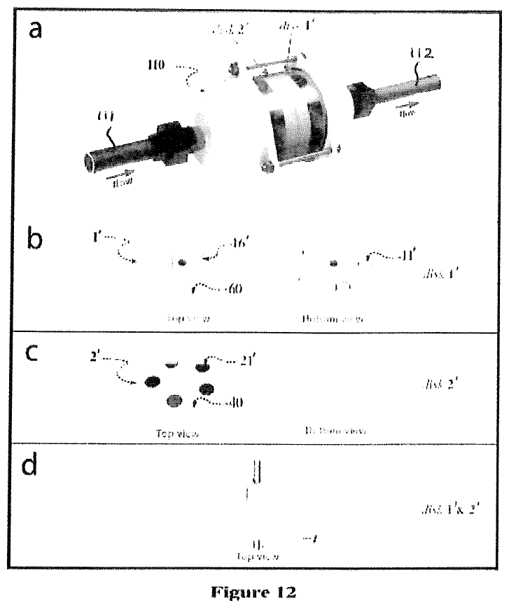

A second type of device 110 is based on the previously described elemental configuration in that it is also constructed with the combination of 5*k coils 11′, 12′, 13′, 14′, 15′, and an equal number of magnets 21′, 22′, 23′, 24′, 25′. FIGS. 12a & 12b show: i) the two sides (up and down) resp. of disc 1′ along with the wiring 16′ of the coils 11′, . . . and the holes 60 in that through which the fluid is passed, and FIG. 12c shows ii) the sides up of disc 2′, and FIG. 12d iii) their combination in this proposed second type device 110.

According to the operating principle of the proposed apparatus, the rotation of disc 1′ is automatically triggered by the flow of fluid, which is channeled through its structure. The energy required to rotate disc 1′ is derived from the kinetic energy of the liquid, as it passes through properly shaped apertures 40, 60, depending on its viscosity.

FIG. 12 illustrates such an alternative structure of device 110 including discs 1′, 2′ for this class of devices 110, and how it is connected to the fluid flow network by means of an adapted input duct 111 through which the fluid is fed to the device 110 and an output duct 112 supplying treated fluid. These holes are mandatory only for the type 110. For 100, the discs do not have holes, since their rotation occurs from an external and as described electric motor.

The mechanism by which the apparatus functions is enlightened on the basis of the theory of quantum electrodynamics. In general, quantum electrodynamic theory deals with the manner in which electromagnetic fields interact with atoms and molecules, as well as the resultant interactions between molecules. The theory of quantum electrodynamics is, in part, based on the relation between the energy of a quantum of light, the photon, and the frequency of any electromagnetic field corresponding to it. In applying quantum electrodynamics to the present electromagnetic system of apparatus and method, it is assumed that dynamic electromagnetic fields are known to interact with the various charged particles which form constituents of atoms and molecules, i.e. electrons. As a result, the external application of an electromagnetic field will bring about various disruptions of the internal fields which are responsible for the particular atomic or molecular structure and the interrelationships of the charged particles therein.

The exact mechanism of the effect of electromagnetic field on water or other fluids is still unclear though. However, according to several research groups, electromagnetic or magnetic treatment of water affects the behavior of inorganic and organic materials in it, including crystallization and biological processes. By electromagnetizing water, its molecules line up in a “+−+−” sequence. This process changes fluid's properties, notably by decreasing its surface tension and viscosity, increasing dissolvability, increasing permeability and oxygen content.

Thus, depending on the atomic or molecular matter present, e.g. of extraneous polluting matter in a liquid to be treated, i.e. purified, the energy absorption/emission characteristics of a solution will depend basically on the frequency of the external electromagnetic field applied. This illustrates the important role of said frequency, since by playing thereon based upon a suitable setting of the associated parameters mentioned above, one is enabled to impact on said energy characteristics of said solution, thereby improving the aforementioned associated applications accordingly.

Strikingly, the utilization of the proposed electro-magnetized water, resp. fluid treatment method and the proposed apparatus incorporating the unique spreading and distribution of electromagnetic field in space, with its unique repetition symmetry, pointedly results in a remarkable improvement in several fields of applications, as depicted in the following examples but not limited thereto.

### EXAMPLE 1

The proposed method and apparatus for the electromagnetic treatment of water or other fluid was tested in the growth rate of bean seeds. Specifically, the growth rate of bean seeds was watered daily either with a small amount of electromagnetically treated water designated as “φ-water” by reference to the key role of the golden ratio being associated to pentagonal like design of the electromagnetic array arrangements of the invention, or with the same amount of water without being subjected to the proposed electromagnetic field designated as “c-water”, and compared.

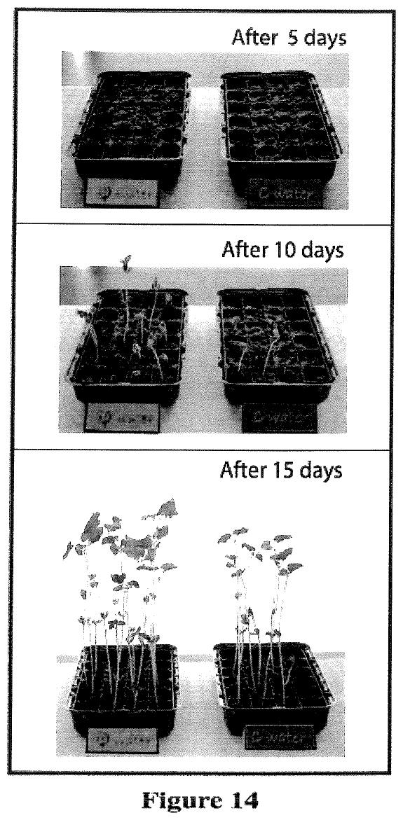

Results are presented in FIG. 14 and they show that beans being subjected to “φ-water” revealed a growth rate for several days which is at least 25%-30% greater compared to that of seeds watered with exactly the same amount of untreated “c-water”, which is visible at several stages after 5 days, 10 days and 15 days respectively.

### EXAMPLE 2

Additionally, the proposed method and apparatus for the electromagnetic treatment of water or other fluids was also tested with regard to the population growth rate of Chlorella vulgaris microbes.

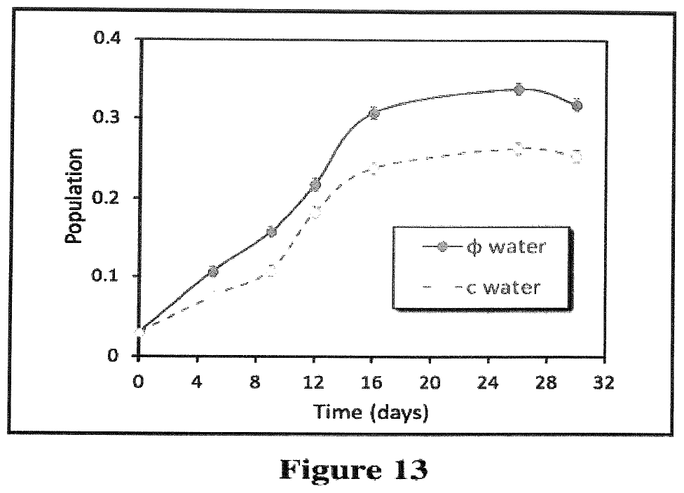

On the basis of the culture growth curves presented in FIG. 13, a positive effect of electromagnetic irradiation of the aqueous solution with the nutrient medium is observed before inoculation with Chlorella vulgaris cells resp. microbes. The positive effect of the irradiated water “ϕ-water” results in an additional increase in biomass production of about 15%-20% compared to the control cultures in which the untreated water “c-water” was used.

The proposed electromagnetic treatment method of fluids and device may be applied in several application areas, examples of which include farming and agricultural applications, industrial applications, i.e. reduction—or even elimination—of scaling salts and corrosion in industrial water facilitating systems, environmental and household uses, such as in sewage systems and in restoring house plumbing, mammal health and cattle-breeding, cosmetics, pharmaceuticals and others, without being limited thereto.

### REFERENCES

[1] K. G. A, S. R. A, M. Garg, R. Mathur, M. Sharma, A. Khairwa, Effect of Magnetized Water Mouthrinse on Streptococcus mutans in Plaque and Saliva in Children: An in vivo Study, International journal of clinical pediatric dentistry 10(4) (2017) 335-339.
[2] M. M. Alam, R. Rahman, N. Biswas, S. Rahman, M. Sultan, Bactericidal effect of electromagnetic field on water, Bangladesh Journal of Microbiology 27 (2010) 67-70
[3] E. Al-Jubouri, J. Hamza, Magnetic water treatment technology and its impact in the field of agriculture, 2012.
[4] H. Arabshahi, M. R. Saeidi, B. Mahdavi, The Effect of Magnetic Water on Growth and Quality Improvement of Poultry, Middle-East Journal of Scientific Research 3 (2008) 140-144.
[5] S. Ebrahim, A. Azab, Biological Effects of Magnetic Water on Human and Animals, Biomedical Sciences 3 (2017) 78-85.
[6] M. El Sabry, J. Charal, K. McMillin, T. Lavergne, Does magnetized drinking water affect productivity and egg quality of layers?, 55 (2018) 117-123.
[7] N. Gupta, M. Bhat, Comparative Evaluation of 0.2 percent Chlorhexidine and Magnetized Water as a Mouth Rinse on Streptococcus mutans in Children, International journal of clinical pediatric dentistry 4(3) (2011) 190-194.
[8] M. Hachicha, B. Kahlaoui, N. Khamassi, E. Misle, O. Jouzdan, Effect of electromagnetic treatment of saline water on soil and crops, Journal of the Saudi Society of Agricultural Sciences 17 (2018) 154-162.
[9] M. Latva, J. Inkinen, J. Rämö, T. Kaunisto, R. Mäkinen, M. Ahonen, J. Matilainen, S. Pehkonen, Studies on the magnetic water treatment in new pilot scale drinking water system and in old existing real-life water system, Journal of Water Process Engineering 9 (2016) 215-224.
[10] H. J. Lee, M. H. Kang, Effect of the magnetized water supplementation on blood glucose, lymphocyte DNA damage, antioxidant status, and lipid profiles in STZ-induced rats, Nutrition research and practice 7(1) (2013) 34-42.
[11] S. Ozdemir, O. H. Dede, G. Koseoglu, Electromagnetic Water Treatment and Water Quality Effect on Germination, Rooting and Plant Growth on Flower, 2005.
[12] D. C. Patterson, D. M. B. Chestnutt, The effect of magnetic treatment of drinking water on growth, feed utilisation and carcass composition of lambs, Animal Feed Science and Technology 46(1) (1994) 11-21.
[13] R. Selamat, I. Abustan, M. Arshad, N. H. Mokhtar Kamal, Removal of Escherichia Coli Using Low-Frequency Electromagnetic Field in Riverbank Filtration, 2019.
[14] J. Teixeira da Silva, J. Dobránszki, Impact of magnetic water on plant growth, Environmental and Experimental Biology 12 (2014) 137-142.
[15] R. E. W. H. Stickler, Mequon, WI, 53092), Eggerichs, Terry L. (2604 W Rogers, Milwaukee, WI, 53215), Larson, Kenneth J. (320 Joanne Dr., Brookfield, WI, 53005), Electromagnetic water treating device, STICKLER; RAYMOND E.,EGGERICHS; TERRY L.,LARSON; KENNETH J., United States, 1987.
[16] M. F. N. t. A. Brigante, Miami, FL, 33169), Electromagnetic ground water conditioning system and sampling device for waste water and fermentation makeup water, BRIGANTE; MIGUEL F., United States, 1982.
[17] D. S. B. Morse, CA), Method and system for variable frequency electromagnetic water treatment, Aqua Dynamics Group Corp. (Wilmington, DE), USA, 1990.
[18] R. B. B. Williams, TX), Nadkarni, Ramachandra A. (Baytown, TX), Use of electromagnetic radiation to recover alkali metal constituents from coal conversion residues, Exxon Research & Engineering Co. (Florham Park, NJ), USA, 1982.
[19] M. F. N. t. A. Brigante, Miami, FL, 33169), Unitary package for water treatment for attachment to home hot water heater, BRIGANTE, MIGUEL F, United States, 1979
[20] R. B. B. Roch, Suite 204, Miami, FL, 33137), Magneto electrochemical reactor, ROCH; RICARDO, United States, 1984.
[21] D. J. R. Van Gorp, Pella, IA, 50219), Magnetic water treatment apparatus and method of treating water, VAN GORP, DONALD J., United States, 1983.
[22] D. C. Avampato, METHOD AND APPARATUS FOR REMOVING IONS FROM WATER, Dominic, Avampato C., United States, 1970.

1. Electromagnetic treatment apparatus for a fluid, notably water, comprising an electromagnetic radiation generator means for generating an electromagnetic signal (sμ) with a targeted spreading and distribution in space,
wherein said electromagnetic radiation generator means (100; 110) comprises electromagnetic means (21, . . . ,25), and supporting means (2; 2′) consisting of a circular plate constituted by a disc (2; 2′) that is rotatably arranged on axis ( [symbol] ) passing through its center (82), further comprising an array (20) of magnet means (21, . . . ,25) arranged on said disc (2, 2′) according to a circular pattern concentric about said axis ( [symbol] ), wherein said array is encompassed within the circumference of said disc (2; 2′),
wherein said electromagnetic radiation generator means (100; 110) further comprises electric means (11, . . . ,15) including an array (10) of coil means (11, . . . ,15) with a coil and magnet wiring means (16) arranged with a predetermined location, further comprising an additional supporting means (1 ; 1′) consisting of a corresponding circular plate with an additional disc (1; 1′), wherein both said discs (1,2; 1′, 2′) are positioned opposite to each other in parallel at a certain distance (d), and rotatably arranged independently on said axis ( [symbol] ) passing through their centers (81, 82) thereby connecting them,
wherein said array (10) of coil means (11, . . . ,15) corresponds to said magnetic array (20) with the same number of electric coil, respective magnet means (21, . . . ,25), both (10, 20) in mutual alignment and arranged on said respective electric and magnetic discs (1, 1′; 2, 2′) according to one circular pattern concentric about said axis ( [symbol] ), wherein each said array (10, 20) is encompassed peripherally within the circumference of each of both said discs (1,1′;2,2′) and in that said coil means (11, . . . ,15), respectively magnet means (21, . . . ,25) are both centered on each vertex of a regular polygon having a fivefold of vertices, in particular five, which are successively arranged equidistantly in said circular pattern, wherein said polygon consists of a regular pentagon, or possibly a regular polygon having k times five vertices wherein k is an integer>1.

2. Electromagnetic treatment apparatus according to claim 1, wherein said electromagnetic radiation generator means (100; 110) is subdivided into two complementary portions (a, b), mutually cooperating together, and which constitute a magnetic portion (b) and an electric portion (a) respectively, which are mutually separated by an interstitial gap (ε) extending planarly between both (a, b), wherein said electric portion (a) and said magnetic portion (b) are mutually juxtaposed,
wherein said electric portion (a) of said electromagnetic radiation generator (100, 110) further comprises a one-dimensional array (10) of coil means (11, . . . ,15) and said magnetic portion (b) comprises a corresponding one-dimensional array (20) of the same number of magnet means (21, . . . ,25) in alignment therewith, both (10, 20) arranged on said respective pair of discs (1, 1′; 2. 2′) according to a circular pattern concentric about said axis ( [symbol] ), wherein said one-dimensional arrays are encompassed peripherally within the circumference of said discs.
wherein said polygon consists of a regular pentagon—or a regular polygon having k times five vertices wherein k is an integer≥3—, wherein said generated electromagnetic radiation signal (sμ) associated to said pentagonal circuitry (11, . . . ,25; 16) is related to the so-called golden ratio (ϕ) defining the geometric proportion of any regular pentagon, wherein
$$φ = \frac{1 + √ 5}{2} ∼ 1.618 ,$$
and wherein said coil means (11, . . . ,15) are all assembled in series.

3. (canceled)

4. Apparatus according to claim 1, characterized in that the coil means (11, . . . ,15) are mutually connected in series as a regular pentagram, with said coil means located at each vertex of said pentagram, wherein said coil means (11 to 15) are arranged at the five tips (i, ii, iii, iv, v) respectively of said pentagram, and in that each coil means (11, . . . ,15) is connected to the pair of non-adjacent coil means located opposite (11 with 13 & 14, 12 with 15 & 14, 13 with 11 & 15, 14 with 11 & 12, and 15 with 12 & 13) according to a star-shaped crossing connection pattern, wherein the connecting sections (17) cross each other,
wherein the said pentagram has a special number hidden inside it corresponding to said golden ratio (ϕ), wherein two quantities a and b (with a>b) are considered to follow the golden ratio (ϕ) if the ratio of their sum (a+b) to the largest quantity a is equal to the ratio of the largest quantity a to the smallest b, that is according to expression (a+b)/a=a/b=ϕ, whereas several characteristic length ratios of said pentagram yield said golden ratio (ϕ), such as (a+b)/a=a/b, and
wherein the electromagnetic radiation field has a repetition symmetry for every 4π, in that said electromagnetic radiation field is repeated every 4π.

5. (canceled)

6. Apparatus according to claim 1, wherein said arrays (10, 20) of coil means (11, . . . ,15), respectively magnet means (21, . . . ,25) are arrayed in one circular alignment on one single circle line (O) on which all said coil means and magnet means are arranged respectively.

7. Apparatus according to claim 1, wherein said magnet means (21, . . . ,25) have a substantially cylindric shape protruding from said magnetic disc (2, 2′) over a height (h) with the top directed to the coils (11, . . . ,15) so as to leave a small gap (ε) between said coils and magnet means when mounted, so as to allow free relative movement between both said first and second discs (1, 1′; 2, 2′), and/or wherein the magnetic array (20) is composed of mutually unconnected magnetic means (21, . . . ,25).

8. (canceled)

9. Apparatus according to claim 1, wherein at least one of the magnet means (21, . . . ,25) is made from neodymium, and/or wherein at least one of the magnet means (21, . . . ,25) is made from a mixture of various compounds comprising neodymium providing an equivalent strength.

10. (canceled)

11. Apparatus according to claim 1, wherein said generator means (100) further comprise driving means (53, 54) which are mutually independent for mutually rotating said discs (1, 2) independently, wherein the relative rotation is generated by electric motors (51, 52) that are controlled by a rotation control device (55); and in that an electromagnetic field with a customized spreading and distribution in space is yielded by said coil-magnet location and wiring for said electromagnetic treatment of said fluid.

12. Apparatus according to claim 1, wherein a regulating means (30) is placed on top of said electromagnetic radiation generator device (100) on its outer surface (39) for allowing a passage of said fluid therein through an input (31), out of it (100),
wherein said regulating means (30) incorporates an extended pathway (32) for the flow (F) of the incoming fluid to be treated, wherein said pathway (32) has a spiral like shape, in particular circular or hemi-circular, more particularly with substantially constant section, starting from said input (31) to evolve as circular windings (33) in progress with further windings downsizing to the center of the top surface (34) of said regulating means (30) constituting the output (35) of said regulating means (30) from which said flow (F) of the fluid, and
wherein said fluid pathway (32) is arranged on the outer surface (39) of said generator means (100).

13. (canceled)

14. (canceled)

15. Apparatus according to claim 1, further comprising a frame (99) wherein said electromagnetic radiation generator device (100) is mounted, with said electric coils (11, . . . ,15) and magnet means (21, . . . ,25) being disposed with said interstitial gap (ε) inbetween and provided with setting means (98).

16. Apparatus according to claim 1, characterized in that said generator means (110) comprise said magnetic discs (1′, 2′) provided with a set of passing means arranged therein consisting of shaped apertures (60, 40) for allowing a passage therethrough for said fluid,
wherein said apertures (40, 60) have a prismatic shape with a triangular section with top oriented to the center of the disc (1′; 2′); and
wherein said apertures (40, 60) are arranged between successive electric coils (11, . . . 15), and respectively magnet means (21, . . . ,25) in the respective first and second discs (1′, 2′), thereby extending radially from the disc perimeter to its center.

17. (canceled)

18. (canceled)

19. Apparatus according to claim 1, wherein said coil wiring (16′) is incorporated on the outer surface of the first coil disc (1′), whereas the coils (11, . . . 15) are incorporated at the inner side thereof; and
wherein said magnet means (21′, . . . 25′) are incorporated on the inner side of said second disc (2′) for actively cooperating with said coil means (11′, . . . , 15′).

20. Apparatus according to claim 1 wherein the apparatus is portable and compact with overall dimensions being limited and with a limited maximum weight.

21. Method of electromagnetic treatment of a fluid, particularly liquid, resp. water, by an electromagnetic signal, for operating an apparatus as defined in claim 1, wherein an electromagnetic signal (s_{μ}) is generated with a targeted spreading and distribution in space by an electromagnetic radiation generator means,
wherein electromagnetic means (11, . . . , 15; 21, . . . ,25) including a coil and magnet wiring means (16) arranged in a regular pentagon or a regular polygon having k times five vertices, wherein k is an integer≥3, on respective first and second discs (1, 1′; 2, 2′) independently rotatable on an axis ( [symbol] ), wherein said method comprises the steps of:
a) generating an electromagnetic signal (s_{μ}) by mutually rotating both said discs (1, 2; 1′, 2′) each with their angular velocities (ω₁, ω₂) respectively, wherein the relative angular velocity Δωᵢ of the relative rotational motion of said two discs produces said targeted electromagnetic radiation, the frequency of which is determined by the relative angular velocity of said two discs and
b) passing untreated fluid through said electromagnetic signal (_{μ}) under the action whereof an electromagnetic field is generated with a customized spreading and distribution in space, as well as a customized repetition symmetry,
wherein the electromagnetic radiation field is generated with a repetition symmetry corresponding to 4kπ, wherein it is determined by selecting the natural number k through the coil-magnet location and wiring (16) on which it depends.

22. (canceled)

23. Method according to claim 21, wherein, characterized in that said fluid is passed in said regulating means (30) on top (34) on the outer surface of said electromagnetic radiation generator device (100) outside thereof (100), through an input (31), wherein the exposure of said fluid to the generated electromagnetic radiation signal (s_{μ}) in said regulating means (30) is regulated by the selected flow (F) of said incoming fluid, wherein the exposure time (t) is dependent on the fluid flow (F) rate by which it is determined, which is regulated by varying the input of said fluid flow (F) rate, and
wherein said flow (F) of the incoming fluid is entered in the regulating means (30) through an extended spiral like pathway (32) in which it is treated outside of the generator means (100), starting from said input (31) to evolve through circular windings (33) to the center of the top surface (34) of said regulating means (30) constituting the output (35) thereof (30), from which said flow (F) of the fluid leaves said electromagnetic radiation generator apparatus (100) after having been treated in said regulating means (30) but outside of said electromagnetic radiation generator apparatus (100).

24. (canceled)

25. (canceled)

26. Method according to claim 21, further comprising the step of, electromagnetizing said fluid by which its molecules are lined up in a “+−+−” sequence, alternating positive and negative polarities, said fluid's properties thus changing therewith, including by decreasing its surface tension and viscosity, increasing dissolvability, increasing permeability and oxygen content, and
wherein the frequency of the external electromagnetic field applied is established and the energy absorption/emission characteristics of a solution formed by said fluid are determined depending on the targeted exogenous atomic or molecular matter present in said fluid.

27. (canceled)

28. Method according to claim 21, wherein, the relative rotation of said discs (1, 2) in said apparatus (100) is generated by generator means, which are controlled by control means.

29. Method according to claim 21, wherein the flow (F) of said fluid is selected, whereas the rotation of the first disc (1′) is automatically triggered by the flow (F) of said fluid, which is channeled through said electromagnetic radiation generator device (110), particularly to start from its said top, wherein the energy required to rotate the first disc (1′) is drawn from the kinetic energy (Eₖᵢₙ) of the incoming fluid to be treated, as it passes through said shaped apertures (60, 40), depending on its viscosity

30. Method according to claim 21, further comprising the step of, setting the power of the electromagnetic radiation to be generated by said electromagnetic radiation generator device (110) for the targeted fluid treatment that is established from a combination of parameters of which it is derived, that are determined by the relative angular velocity Δω of the two discs (1′, 2′), the characteristics of the magnets and coils, as well as on the distance (d) between said coil means (11, . . . ,15) and magnet means (21, . . . ,25), on which the said power depends, wherein said power is thus regulated by setting the parameters of said characteristics through said relative angular velocity of both discs.

31. Method according to claim 21, wherein
said fluid to be treated is selected as an aqueous solution or suspension,
which is prepared with a nutrient medium,
an electromagnetic irradiation of said preparation of aqueous solution with the nutrient medium is generated before its inoculation with cells, in particular Chlorella vulgaris microbes, based upon a set of reference culture growth curves,
thereby yielding irradiated water the use whereof results in an incremented increase in biomass production of about 15%-20% compared to reference control cultures in which untreated water is used.

32. (canceled)

33. Method of increasing the growth rate of beans comprising watering bean seeds with electromagnetically treated water produced according to the method of claim 20, wherein said beans being subjected to said electromagnetically treated water having at least 25% greater growth rate for several days compared to that of seeds watered with the same amount of untreated water.

34. Method of producing electromagnetically-treated fluid, comprising placing a container containing fluid selected from the group consisting of pharmaceuticals, cosmetics, and health care products on the upper outer surface (39) of the fluid treatment device of claim 1 containing said electromagnetic radiation generator (100), wherein said container (91, 92) with said fluid is then exposed to the generated electromagnetic radiation (s_{μ}).

35. (canceled)
